(19) United States
(12) Patent Application Publication
(10) Pub. No.: US 2026/0249374 A1
(43) Pub. Date: Aug. 27, 2026

(54) METHOD OF MANUFACTURING JOINED BODY

(71) Applicant: FUTABA INDUSTRIAL CO., LTD., Aichi (JP)

(72) Inventors: Hitomi ASANO, Aichi (JP); Shinya AZUCHI, Aichi (JP); Daisuke ITO, Aichi (JP)

(21) Appl. No.: 19/544,332

(22) Filed: Feb. 19, 2026

(30) Foreign Application Priority Data
Feb. 26, 2025 (JP) 2025-029409

(51) Int. Cl. B23K 9/00

(52) U.S. Cl. CPC B23K 9/0026

(57) ABSTRACT

A method of manufacturing a joined body includes joining a first plate portion and a second plate portion together by forming a penetration portion extending from the second plate portion to the first plate portion in a region where a weld bead is formed. The weld bead includes a first weld portion, a second weld portion, and a third weld portion. The first weld portion and the second weld portion form a loop portion as a loop-shaped weld portion. A terminal end of the third weld portion as a terminal end of the weld bead is formed on an inner peripheral side of the loop portion. An amount of heat supplied to a region to be heated during formation of the third weld portion is controlled to be smaller than an amount of heat supplied to the region to be heated during formation of the first weld portion.

### CROSS-REFERENCE TO RELATED APPLICATIONS

This application claims the benefit of Japanese Patent Application No. 2025-029409 filed on February 26, 2025 with the Japan Patent Office, the entire disclosure of which is incorporated herein by reference.

### BACKGROUND

The present disclosure relates to a method of manufacturing a joined body.

For example, Japanese Unexamined Patent Application Publication No. 2024-139356 discloses a technique of stacking a first plate portion and a second plate portion one on top of another in their plate thickness directions, and then welding them together, in which a loop portion as a loop-shaped weld portion is formed and a terminal end of a weld bead is positioned inside a closed region surrounded by the loop portion.

According to such a technique, a gap between the first plate portion and the second plate portion is sealed in a region where the loop portion is formed. Therefore, for example, even in a case in which a flow path for a fluid is positioned on an outer peripheral side of the loop portion and the fluid may enter the gap between the first plate portion and the second plate portion, the fluid can be inhibited from reaching an inner peripheral side of the loop portion.

Therefore, under the condition that the terminal end of the weld bead is positioned on the inner peripheral side of the loop portion as described above, even in a case in which defects such as blowholes, pits, or cracks occur at the terminal end of the weld bead, the fluid can be inhibited from reaching the terminal end of the weld bead, and thus leaking of the fluid can be suppressed.

### SUMMARY

However, as a result of detailed examination by the present inventors, it was found that, under the condition that the terminal end of the weld bead is positioned inside the region surrounded by the loop portion as described above, an excessively deep penetration may occur in the vicinity of the terminal end of the weld bead. If such deep penetration causes backside scorching or burn-through, some products may fail to meet quality requirements.

In one aspect of the present disclosure, it is desirable to provide a method of manufacturing a joined body that can inhibit occurrence of excessive penetration.

(1) In one mode of the present disclosure, a method of manufacturing a joined body is provided. The method comprises: placing a first plate portion and a second plate portion that are plate-shaped portions such that the first plate portion and the second plate portion are stacked one on top of another in their plate thickness directions; and thereafter joining the first plate portion and the second plate portion together by heating a region to be heated that is located along a weld line from a second plate portion side of the first plate portion and the second plate portion that are stacked, thereby forming a weld bead that extends from a starting end to a terminal end of the weld bead while forming a penetration portion that extends from the second plate portion to the first plate portion in a region where the weld bead is formed. The weld bead includes a first weld portion, a second weld portion, and a third weld portion, each forming a respective part of the weld bead. The first weld portion and the second weld portion are formed continuously such that a terminal end of the first weld portion coincides with a starting end of the second weld portion, and a part of the second weld portion that is different from the starting end of the second weld portion is formed at a position that overlaps a part of the first weld portion, whereby the first weld portion and the second weld portion form a loop portion that is a loop-shaped weld portion. In the third weld portion, the second weld portion and the third weld portion are formed continuously such that a terminal end of the second weld portion coincides with a starting end of the third weld portion, and a terminal end of the third weld portion that is the terminal end of the weld bead is formed on an inner peripheral side of the loop portion. Control is carried out such that an amount of heat supplied to the region to be heated during formation of the third weld portion is smaller than an amount of heat supplied to the region to be heated during formation of the first weld portion.

According to the method of manufacturing the joined body configured as described above, the first weld portion and the second weld portion form the loop portion, and the terminal end of the third weld portion that is the terminal end of the weld bead is formed on the inner peripheral side of the loop portion. Furthermore, the control is carried out such that the amount of heat that is supplied to the region to be heated during the formation of the third weld portion is smaller than the amount of heat that is supplied to the region to be heated during the formation of the first weld portion.

Therefore, the amount of heat supplied to the region to be heated during the formation of the third weld portion is reduced relative to that during the formation of the first weld portion. As a result, compared with a conventional technique in which no control is carried out to increase or reduce the amounts of heat supplied to the region to be heated, occurrence of excessive penetration can be inhibited.

(2) In one mode of the present disclosure, the control may be carried out such that an amount of heat supplied to the region to be heated during formation of the second weld portion is smaller than the amount of heat supplied to the region to be heated during the formation of the first weld portion and is larger than the amount of heat supplied to the region to be heated during the formation of the third weld portion.

According to the method of manufacturing the joined body configured as described above, the amount of heat supplied to the region to be heated during the formation of the second weld portion is reduced relative to that during the formation of the first weld portion. Furthermore, the amount of heat supplied to the region to be heated during the formation of the third weld portion is reduced relative to that during the formation of the second weld portion. As a result, compared with a conventional technique in which no control is carried out to increase or reduce the amounts of heat supplied to the region to be heated, occurrence of excessive penetration can be inhibited.

(3) In one mode of the present disclosure, the control may be carried out such that the amount of heat supplied to the region to be heated during the formation of the first weld portion, the amount of heat supplied to the region to be heated during the formation of the second weld portion, and the amount of heat supplied to the region to be heated during the formation of the third weld portion are gradually reduced in a stepwise manner or in a continuous manner.

According to the method of manufacturing the joined body configured as described above, the amounts of heat that are supplied to the region to be heated during the formations of the first weld portion, the second weld portion, and the third weld portion are gradually reduced in a stepwise manner or in a continuous manner. As a result, compared with a conventional technique in which no control is carried out to increase or reduce the amounts of heat supplied to the region to be heated, occurrence of excessive penetration can be inhibited.

(4) In one mode of the present disclosure, the control for reducing the amounts of heat may be control for reducing an output of a source for the heating.

According to the method of manufacturing the joined body configured as described above, the amounts of heat that are supplied to the region to be heated are reduced by reducing the output of the source for the heating. Therefore, even in a case in which, for example, a welding speed is maintained at a constant speed, the amounts of heat that are supplied to the region to be heated can be increased or reduced.

(5) In one embodiment of the present disclosure, the control for reducing the amounts of heat may be a control for increasing a welding speed.

According to the method of manufacturing the joined body configured as described above, the amounts of heat that are supplied to the region to be heated are reduced by increasing the welding speed. Therefore, even in a case in which, for example, an output of the source for the heating is maintained at a constant output, the amounts of heat that are supplied to the region to be heated can be increased or reduced.

(6) In one mode of the present disclosure, the first weld portion, the second weld portion, and the third weld portion may include portions extending parallel to each other where the third weld portion is formed between the first weld portion and the second weld portion.

### BRIEF DESCRIPTION OF THE DRAWINGS

An example embodiment of the present disclosure will be described hereinafter with reference to the accompanying drawings, in which:

FIG. 1A is an exploded perspective view of a joined body;

FIG. 1B is a cross-sectional view of the joined body showing a cut plane perpendicular to the x-axis;

FIG. 2A is a bottom view of the joined body;

FIG. 2B is an enlarged view of a second weld line near a terminal end of the second weld line;

FIG. 3A is an explanatory view of the joined body in a state in which a first weld portion has been formed;

FIG. 3B is a cross-sectional view of the joined body taken along a line IIIB-IIIB shown in FIG. 3A;

FIG. 4A is an explanatory view of the joined body in a state in which a second weld portion has been formed in addition to the first weld portion;

FIG. 4B is a cross-sectional view of the joined body taken along a line IVB-IVB shown in FIG. 4A;

FIG. 5A is an explanatory view of the joined body in a state in which a third weld portion has been formed in addition to the first weld portion and the second weld portion;

FIG. 5B is a cross-sectional view of the joined body taken along a line VB-VB shown in FIG. 5A; and

FIG. 6 is an enlarged view of a second weld line near a terminal end of the second weld line as exemplified in another embodiment.

### DETAILED DESCRIPTION OF EXEMPLARY EMBODIMENTS

Next, a method of manufacturing a joined body will be described with reference to an exemplary embodiment.

### Configuration of Joined Body

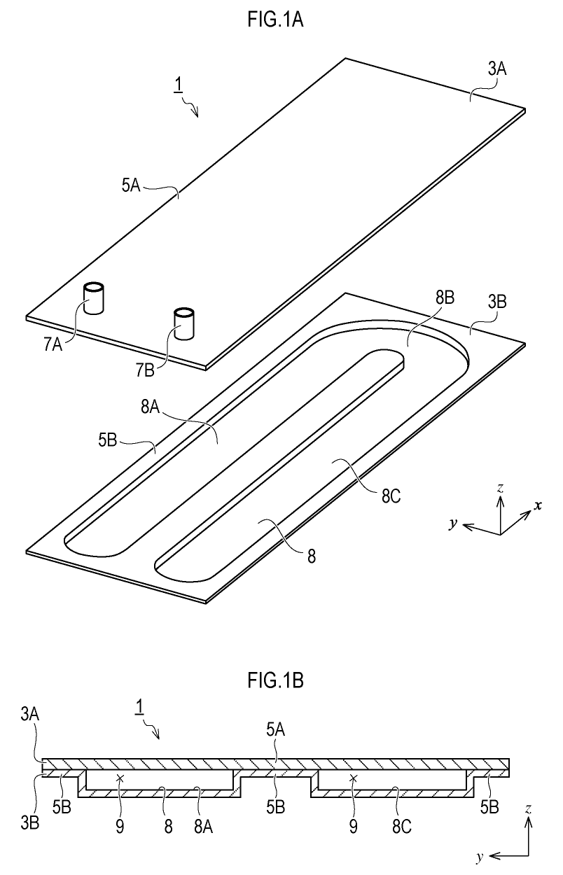

As shown in FIG. 1A, a joined body 1 exemplified in an embodiment of the present disclosure is a heat exchanger for cooling a heat-generating body. The joined body 1 is, for example, mounted in a vehicle (not shown) and is used to cool a drive battery mounted in the vehicle. The joined body 1 includes a first member 3A and a second member 3B. Component materials of the first member 3A and the second member 3B are not particularly limited. In one example, the first member 3A and the second member 3B are made of a metallic material, such as iron, stainless steel, or aluminum, or a resin material, such as an engineering plastic, or other equivalent components. Either the metallic material or the resin material may be used, or both the metallic material and the resin material may be used together. For example, in a case in which the first member 3A contacts the heat-generating body, the first member 3A may be made of the metallic material, which has excellent thermal conductivity, and the second member 3B having recesses and projections may be made of the resin material, which has excellent moldability.

The first member 3A includes a first plate portion 5A that is a plate-shaped portion. The second member 3B includes a second plate portion 5B that is a plate-shaped portion. As shown in FIG. 1B, in the first member 3A and the second member 3B, the first plate portion 5A and the second plate portion 5B are stacked one on top of another in their plate thickness directions and are welded together by laser welding from a second plate portion 5B side so that a weld joint is formed as a lap joint. A specific welding method will be described later in detail.

The first member 3A includes an inflow port 7A and an outflow port 7B. The inflow port 7A and the outflow port 7B are tubular portions protruding from the first member 3A. Through holes having diameters equal to those of the inflow port 7A and the outflow port 7B are formed in the first member 3A. The inflow port 7A and the outflow port 7B protrude from peripheries of the through holes.

The second member 3B includes a recess 8. The recess 8 may be formed only in the first member 3A or may be formed in both the first member 3A and the second member 3B. That is, in which of the first member 3A and the second member 3B the recess 8 is formed is not limited. Hereinafter, the present embodiment will be described by way of example of a case in which the recess 8 is formed in the second member 3B. The recess 8 is a portion of the second member 3B that is recessed in a negative z-axis direction, as shown in FIG. 1A. The recess 8 is curved in a U-shape when viewed in the negative z-axis direction. More specifically, the recess 8 includes a first groove 8A, a second groove 8B, and a third groove 8C.

The first groove 8A is a section that extends linearly along the x-axis. The second groove 8B is a section that continuously extends from the first groove 8A. The second groove 8B is a section that curves about the z-axis as a center of curvature with a central angle of the curvature being 180 degrees, that is, a semicircular arc section. The third groove 8C is a section that continuously extends from the second groove 8B and that extends linearly along the x-axis in parallel with the first groove 8A. The second plate portion 5B is a portion of the second member 3B other than the recess 8.

As shown in FIG. 1B, as a result of the first plate 5A and the second plate 5B being stacked one on top of another in their plate thickness directions, a space surrounded by the first member 3A and the recess 8 forms a flow path 9 having a U-shape through which a refrigerant flows. The refrigerant flows into the flow path 9 via the inflow port 7A from a pipe that serves as a supply path and flows out from the flow path 9 via the outflow port 7B to a pipe that serves as a discharge path. The refrigerant that passes through the flow path 9 cools the heat-generating body that is in contact with the first member 3A. It should be noted that the refrigerant may be used in the form of a liquid or a gas.

### Explanation of Welding Method

Next, a welding method of the joined body 1 will be described.

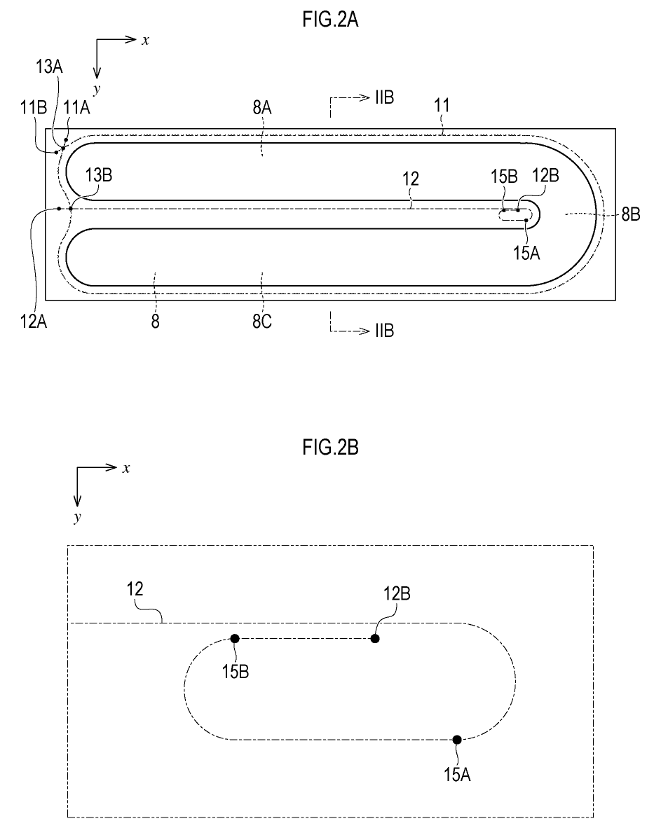

The first member 3A and the second member 3B are welded to each other at the first plate portion 5A and the second plate portion 5B. FIG. 2A shows a first weld line 11 and a second weld line 12 that represent weld portions of the first member 3A and the second member 3B. The first weld line 11 extends from a starting end 11A, form a loop in a region surrounding the recess 8, and then reaches a terminal end 11B. The first weld line 11 intersects itself at an intersection 13A. The first weld line 11 is a line drawable in a single continuous stroke from the starting end 11A to the terminal end 11B.

The second weld line 12 extends from a starting end 12A located on an outer peripheral side of the first weld line 11, intersects the first weld line 11 at an intersection 13B, and then extends to a region on an inner peripheral side of the first weld line 11. A portion of the second weld line 12 that extends linearly along the x-axis from the starting end 12A runs between the first groove 8A and the third groove 8C of the recess 8, and then the second weld line 12 reaches a terminal end 12B located near the second groove 8B of the recess 8. The second weld line 12 is a line drawable in a single continuous stroke from the starting end 12A to the terminal end 12B.

FIG. 2B shows an enlarged view of a shape of the second weld line 12 near the terminal end 12B. The second weld line 12 extends linearly in a positive x-axis direction from the starting end 12A, curves about the z-axis as a center of curvature, and then reaches a position where the central angle of the curvature is 180 degrees. Hereinafter, the reached position is referred to as a “boundary point 15A”. The second weld line 12 extends linearly in a negative x-axis direction from the boundary point 15A, curves about the z-axis as a center of curvature, and then reaches a position where the central angle of the curvature is 180 degrees. Hereinafter, the reached position is referred to as a “boundary point 15B”. The second weld line 12 extends linearly in the positive x-axis direction from the boundary point 15B and reaches the terminal end 12B.

Along the first weld line 11 and the second weld line 12 as described above, laser welding is performed from the second plate portion 5B side. The first weld line 11 is located in the region surrounding an outer periphery of the recess 8 that forms the flow path 9 (see FIG. 1B) and intersects itself at the intersection 13A, thereby forming a closed loop. Accordingly, by performing laser welding on a region extending along the first weld line 11 as a region to be heated, the flow path 9 can be confined on an inner peripheral side of the weld portion that is formed in a closed loop. Therefore, even in a case where a fluid introduced into the flow path 9 enters the gap between the first plate 5A and the second plate 5B, the fluid does not leak to an outer peripheral side of the weld portion extending along the first weld line 11.

Furthermore, the starting end 11A and the terminal end 11B of the first weld line 11 are located on the outer peripheral side of the weld portion formed in a closed loop shape. Therefore, even in a case in which the fluid introduced into the flow path 9 enters the gap between the first plate 5A and the second plate 5B, the fluid does not reach the weld portion near the starting end 11A or the weld portion near the terminal end 11B. In the weld portion near the starting end 11A or the weld portion near the terminal end 11B, defects such as blowholes, pits, and cracks are likely to occur during welding. Since the fluid does not reach such portions where defects are likely to occur as described above, fluid sealing performance of the joined body 1 can be improved.

By performing laser welding on a region extending along the second weld line 12 as a region to be heated, the gap between the first plate portion 5A and the second plate portion 5B can be sealed in a region between the first groove 8A and the third groove 8C of the recess 8. Therefore, short-circuiting between the first groove 8A and the third groove 8C via the gap between the first plate portion 5A and the second plate portion 5B can be inhibited, and thus cooling performance of the flow path 9 having a U-shape can be exhibited as designed.

The starting end 12A of the second weld line 12 is located on the outer peripheral side of the weld portion formed in a closed loop shape along the first weld line 11. Therefore, even in a case where the fluid introduced into the flow path 9 enters the gap between the first plate 5A and the second plate 5B, the fluid does not reach the weld portion near the starting end 12A. In the weld portion near the starting end 12A, defects such as blowholes, pits, and cracks are likely to occur during welding. Since the fluid does not reach such portion where defects are likely to occur as described above, fluid sealing performance of the joined body 1 can be improved.

In the second weld line 12 near the terminal end 12B, welding is performed along the second weld line 12 as shown in FIG. 2B in an enlarged scale. At this time, control for adjusting amounts of heat supplied to the region to be heated is carried out. Specifically, in a first section 17A that extends to the boundary point 15A, an amount of heat Q1 is supplied to the region to be heated. Then, in a second section 17B that extends from the boundary point 15A to the boundary point 15B, an amount of heat Q2 is supplied to the region to be heated. Then, in a third section 17C extending from the boundary point 15B to the terminal end 12B, an amount of heat Q3 is supplied to the region to be heated.

The amounts of heat Q1, Q2, and Q3 satisfy the relationship Q1≥Q2>Q3, and the amounts of heat supplied to the region to be heated are gradually reduced in a stepwise manner. Specific values of the amounts of heat Q1, Q2, and Q3 may be appropriately adjusted. In one example, if the amount of heat Q1 is a standard amount of heat for welding, the amount of heat Q2 may be about 80% of the amount of heat Q1, and the amount of heat Q3 may be about 40% of the amount of heat Q1.

Any method may be used for gradually reducing the amounts of heat Q1, Q2, and Q3 in a stepwise manner. In one example, the amounts of heat Q1, Q2, and Q3 may be gradually reduced in a stepwise manner by adjusting an output of a source for heating. In a case of a constant output of the source for heating, an amount of heat supplied to a region to be heated having a specific length decreases as welding speed is increased. Therefore, the amounts of heat Q1, Q2, and Q3 may be gradually reduced in a stepwise manner by increasing the welding speed in the case of the constant output of the source for heating.

The above example describes gradually reducing the amounts of heat Q1, Q2, and Q3 in a stepwise manner. The amount of heat may be reduced in a greater number of steps, or may be continuously and gradually reduced in a stepless manner. Furthermore, as explicitly indicated by the above inequality, the amounts of heat Q1 and Q2 may be equal, and the amounts of heat Q2 and Q3 may be gradually reduced in a stepwise manner or in a stepless manner.

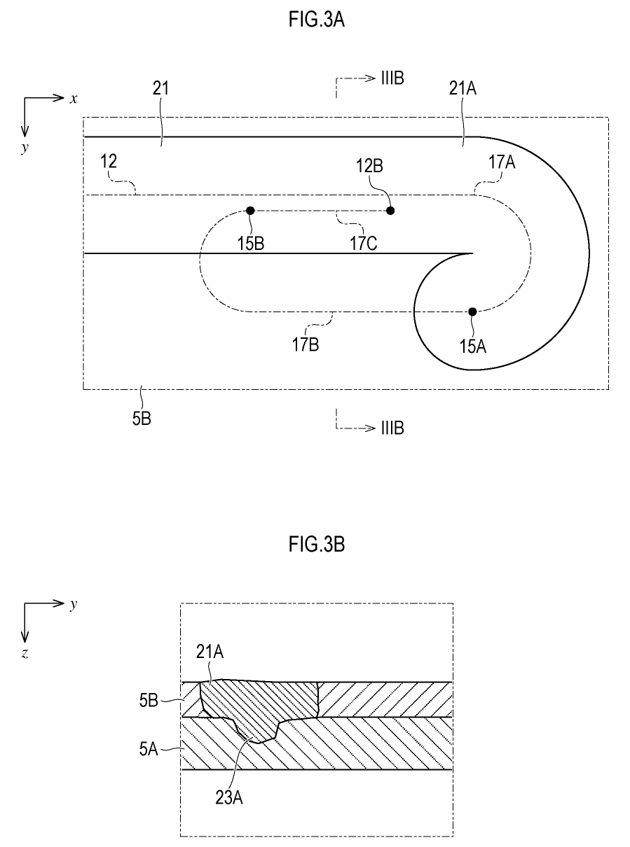

When welding is performed in the first section 17A, a weld bead 21 is formed in a region extending along the first section 17A, as shown in FIGS. 3A and 3B. Hereinafter, the weld bead 21 formed in the region extending along the first section 17A is also referred to as a “first weld portion 21A”. In a region where the first weld portion 21A is formed, a penetration portion 23A that penetrates from the second plate portion 5B to the first plate portion 5A is formed, as shown in FIG. 3B.

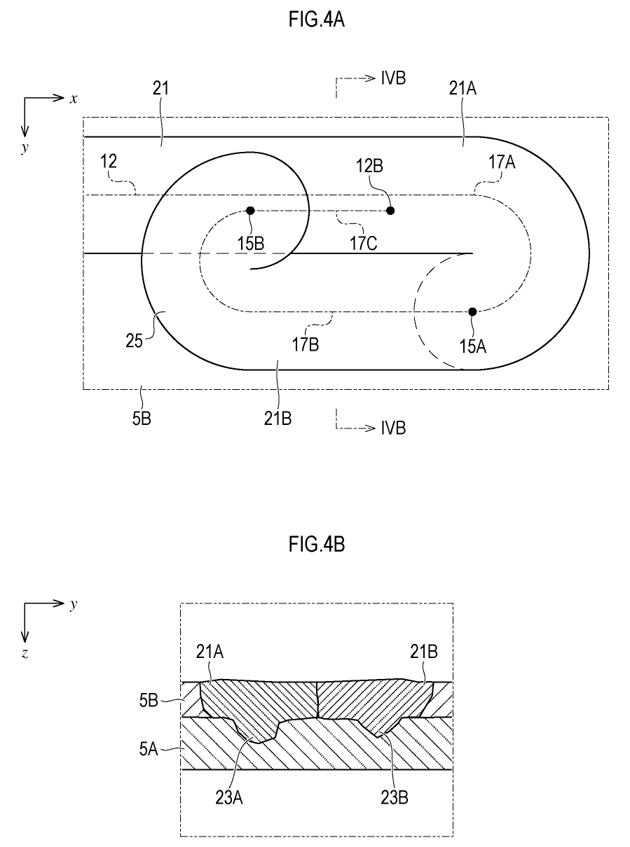

When welding is performed in the second section 17B following the first section 17A, the weld bead 21 is formed in a region extending along the second section 17B, as shown in FIGS. 4A and 4B. Hereinafter, the weld bead 21 formed in the region extending along the second section 17B is also referred to as a “second weld portion 21B”. In a region where the second weld portion 21B is formed, a penetration portion 23B that penetrates from the second plate portion 5B to the first plate portion 5A is formed, as shown in FIG. 4B.

The welding in the second section 17B is performed immediately after the welding in the first section 17A is performed. Therefore, when the welding in the second section 17B is performed, a temperature of the region to be heated has already risen to some extent. However, in the present embodiment, the amount of heat Q2 is supplied to the region to be heated during the welding in the second section 17B, as described above.

Accordingly, the amount of heat supplied to the region to be heated during the welding in the second section 17B is reduced relative to the amount of heat supplied to the region to be heated during the welding in the first section 17A. Thus, formation of the penetration portion 23B having an excessive depth can be inhibited. Thus, compared with a case in which the welding is continued without changing the amounts of heat, burn-through or backside scorching to a first plate 5A side of the joined body 1 can be inhibited, and as a result, smoothness of the first plate 5A side of the joined body 1 can be appropriately maintained.

A terminal end of the first weld portion 21A and a starting end of the second weld portion 21B, which are located at a position coinciding with the boundary point 15A, are formed to overlap with each other at the position coinciding with the boundary point 15A. A terminal end of the second weld portion 21B is located at a position different from a position where the starting end of the second weld portion 21B is located. Also in the vicinity of the terminal end of the second weld portion 21B, a part of the second weld portion 21B is formed at a position that overlaps a part of the first weld portion 21A. As a result, the first weld portion 21A and the second weld portion 21B form a loop portion 25 that is a loop-shaped weld portion.

In the second weld line 12, the second section 17B does not reach a position that overlaps the first section 17A. However, since the weld bead 21 has a specific width, the second weld portion 21B reaches a position that overlaps the first weld portion 21A. As a result, the loop portion 25 forms a closed loop. In other words, the loop portion 25 forms a loop without any openings along its circumferential direction.

In the present embodiment, since the weld bead 21 has a specific width, a region on the inner peripheral side of the loop portion 25 is filled by the loop portion 25 without any gaps. However, a shape without such gaps formed on the inner peripheral side is also included in the “loop portion” as referred to herein. In other words, the “loop portion” as referred to herein has nothing to do with whether a gap exists on the inner peripheral side of the loop portion or not.

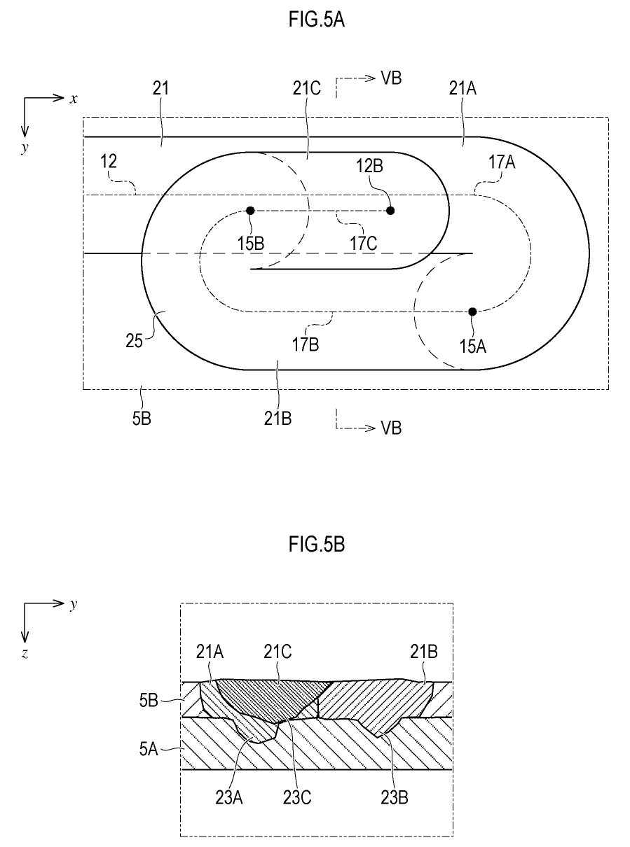

When welding is performed in the third section 17C following the second section 17B, a weld bead 21 is formed in a region extending along the third section 17C, as shown in FIGS. 5A and 5B. Hereafter, the weld bead 21 formed in the region extending along the third section 17C is also referred to as a “third weld portion 21C”. In a region where the third weld portion 21C is formed, a penetration portion 23C is formed, as shown in FIG. 5B.

The welding in the third section 17C is performed immediately after the welding in the second section 17B is performed. Therefore, when the welding in the third section 17C is performed, a temperature of the region to be heated has already risen to some extent. Furthermore, the third weld portion 21C is formed at a position that overlaps the first weld portion 21A and the second weld portion 21B. However, in the present embodiment, the amount of heat Q3 is supplied to the region to be heated during the welding in the third section 17C, as described above.

Accordingly, the amount of heat supplied to the region to be heated during the welding in the third section 17C is reduced relative to the amount of heat supplied to the region to be heated during the welding in the second section 17B. Thus, formation of the penetration portion 23C having an excessive depth can be inhibited. Therefore, compared with a case in which the welding is continued without changing the amounts of heat, burn-through or backside scorching to the first plate 5A side of the joined body 1 can be inhibited, and as a result, smoothness of the first plate 5A side of the joined body 1 can be appropriately maintained.

In a region where the loop portion 25 is formed, the gap between the first plate portion 5A and the second plate portion 5B is sealed in a closed loop shape. Therefore, even in a case in which the fluid introduced into the flow path 9 enters the gap between the first plate 5A and the second plate 5B, the fluid does not reach the region surrounded by the loop portion 25.

A terminal end of the third weld portion 21C that is the terminal end of the weld bead 21 is formed at a position on the inner peripheral side of the loop portion 25. Therefore, even in a case in which the fluid introduced into the flow path 9 enters the gap between the first plate 5A and the second plate 5B, the fluid does not reach the weld portion near the terminal end 12B. In the weld portion near the terminal end 12B, defects such as blowholes, pits, and cracks are likely to occur during welding. Since the fluid does not reach the portion where such defects are likely to occur, fluid sealing performance of the joined body 1 can be improved.

### Effects

As described above, according to the method of manufacturing the joined body 1, the first weld portion 21A and the second weld portion 21B form the loop portion 25, and the terminal end of the third weld portion 21C that is the terminal end of the weld bead 21 is formed at the position on the inner peripheral side of the loop portion 25. Furthermore, control is carried out such that the amount of heat Q3 supplied to the region to be heated during the formation of the third weld portion 21C is smaller than the amount of heat Q1 supplied to the region to be heated during the formation of the first weld portion 21A.

Accordingly, the amount of heat supplied to the region to be heated during the formation of the third weld portion 21C is reduced relative to that during the formation of the first weld portion 21A. Therefore, compared with a conventional technique in which no control is performed to increase or reduce the amounts of heat supplied to the region to be heated, occurrence of excessive penetration can be inhibited.

Moreover, in the present embodiment, the amount of heat supplied to the region to be heated during the formation of the second weld portion 21B is reduced relative to that during the formation of the first weld portion 21A. Furthermore, the amount of heat supplied to the region to be heated during the formation of the third weld portion 21C is reduced relative to that during the formation of the second weld portion 21B. Therefore, compared with a conventional technique in which no control is performed to increase or reduce the amounts of heat supplied to the region to be heated, occurrence of excessive penetration can be inhibited.

### Other Embodiments

Although the method of manufacturing the joined body has been described with reference to the example embodiment, the embodiment is merely an example of one mode of the present disclosure. Accordingly, the present disclosure is not limited to the example embodiment described above, and may be embodied in various forms within the scope of the technical concept of the disclosure.

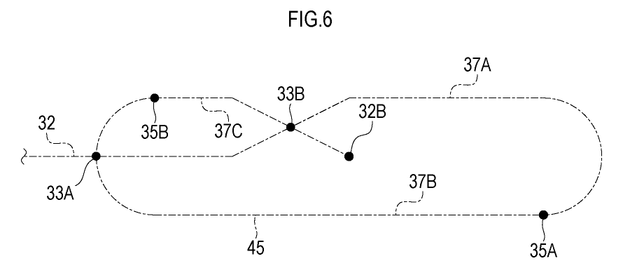

In the above embodiment, the specific shape of the second weld line 12 near the terminal end 12B is described as an example. However, the shape of the second weld line 12 near the terminal end 12B is not limited to the example described above. In another specific example, as in a second weld line 32 shown in FIG. 6, a first section 37A and a second section 37B may intersect at an intersection 33A to form a loop section 45. Also in this case, a terminal end 32B of a second weld line 32 that is a terminal end of a third section 37C can be positioned on an inner peripheral side of the loop section 45. It should be noted that the “loop section 45” as referred to herein is a section where a weld portion that corresponds to the loop portion 25 in the above-described embodiment is formed.

Also in a case in which a weld bead is formed along the second weld line 32 as described above, excessive penetration can be inhibited by reducing the amounts of heat supplied to the first section 37A, the second section 37B, and the third section 37C in this order in a stepwise manner or in a continuous manner.

It should be noted that, in the example shown in FIG. 6, the first section 37A and the second section 37B intersect at the intersection 33A. If the penetration at the intersection 33A is excessive, a boundary point 35B between the second section 37B and the third section 37C may be positioned between the intersection 33A and a boundary point 35A between the first section 37A and the second section 37B along the second weld line 32. Thus, the first section 37A and the third section 37C may intersect at the intersection 33A. If the penetration at the intersection 33B is excessive, the amount of heat may be further reduced at a position near the intersection 33B.

In the above-described embodiment, the heat exchanger for cooling the heat-generating body is described as a specific example of the joined body 1. The method of manufacturing the joined body of the present disclosure can also be employed in manufacturing products other than the heat exchanger.

Two or more functions performed by one element in the above-described embodiments may be achieved by two or more elements. One function performed by one element in the above-described embodiments may be achieved by two or more elements. Two or more functions performed by two or more elements in the above-described embodiments may be achieved by one element. One function performed by two or more elements in the above-described embodiments may be achieved by one element. Furthermore, a part of the configurations in the above-described embodiments may be omitted, and at least a part of the configurations in the above-described embodiments may be added to or replaced with another part of the configurations in the above-described embodiments.

### Technical Ideas Disclosed Herein

### Item 1

A method of manufacturing a joined body, the method comprising:

placing a first plate portion and a second plate portion that are plate-shaped portions such that the first plate portion and the second plate portion are stacked one on top of another in their plate thickness directions; and

thereafter joining the first plate portion and the second plate portion together by heating a region to be heated that is located along a weld line from a second plate portion side of the first plate portion and the second plate portion that are stacked, thereby forming a weld bead that extends from a starting end to a terminal end of the weld bead while forming a penetration portion that extends from the second plate portion to the first plate portion in a region where the weld bead is formed,

wherein the weld bead includes a first weld portion, a second weld portion, and a third weld portion, each forming a respective part of the weld bead,

wherein the first weld portion and the second weld portion are formed continuously such that a terminal end of the first weld portion coincides with a starting end of the second weld portion, and a part of the second weld portion that is different from the starting end of the second weld portion is formed at a position that overlaps a part of the first weld portion, whereby the first weld portion and the second weld portion form a loop portion that is a loop-shaped weld portion, and

wherein, in the third weld portion, the second weld portion and the third weld portion are formed continuously such that a terminal end of the second weld portion coincides with a starting end of the third weld portion, and a terminal end of the third weld portion that is the terminal end of the weld bead is formed on an inner peripheral side of the loop portion,

the method further comprising carrying out control for reducing amounts of heat such that an amount of heat supplied to the region to be heated during formation of the third weld portion is smaller than an amount of heat supplied to the region to be heated during formation of the first weld portion.

### Item 2

The method of manufacturing the joined body according to item 1,

wherein the control for reducing the amounts of heat is carried out such that an amount of heat supplied to the region to be heated during formation of the second weld portion is smaller than the amount of heat supplied to the region to be heated during the formation of the first weld portion and is larger than the amount of heat supplied to the region to be heated during the formation of the third weld portion.

### Item 3

The method of manufacturing the joined body according to item 2,

wherein the control for reducing the amounts of heat is carried out such that the amount of heat supplied to the region to be heated during the formation

of the first weld portion, the amount of heat supplied to the region to be heated during the formation of the second weld portion, and the amount of heat supplied to the region to be heated during the formation of the third weld portion are gradually reduced in a stepwise manner or in a continuous manner.

### Item 4

The method of manufacturing the joined body according to any one of items 1 to 3,

wherein the control for reducing the amounts of heat is control for reducing an output of a source for the heating.

### Item 5

The method of manufacturing the joined body according to any one of items 1 to 4,

wherein the control for reducing the amounts of heat is control for increasing a welding speed.

### Item 6

The method of manufacturing the joined body according to any one of items 1 to 5,

wherein the first weld portion, the second weld portion, and the third weld portion include portions extending parallel to each other where the third weld portion is formed between the first weld portion and the second weld portion.

What is claimed is:

1. A method of manufacturing a joined body, the method comprising:
placing a first plate portion and a second plate portion that are plate-shaped portions such that the first plate portion and the second plate portion are stacked one on top of another in their plate thickness directions; and
thereafter joining the first plate portion and the second plate portion together by heating a region to be heated that is located along a weld line from a second plate portion side of the first plate portion and the second plate portion that are stacked, thereby forming a weld bead that extends from a starting end to a terminal end of the weld bead while forming a penetration portion that extends from the second plate portion to the first plate portion in a region where the weld bead is formed,
wherein the weld bead includes a first weld portion, a second weld portion, and a third weld portion, each forming a respective part of the weld bead,
wherein the first weld portion and the second weld portion are formed continuously such that a terminal end of the first weld portion coincides with a starting end of the second weld portion, and a part of the second weld portion that is different from the starting end of the second weld portion is formed at a position that overlaps a part of the first weld portion, whereby the first weld portion and the second weld portion form a loop portion that is a loop-shaped weld portion, and
wherein, in the third weld portion, the second weld portion and the third weld portion are formed continuously such that a terminal end of the second weld portion coincides with a starting end of the third weld portion, and a terminal end of the third weld portion that is the terminal end of the weld bead is formed on an inner peripheral side of the loop portion,
the method further comprising carrying out control for reducing amounts of heat such that an amount of heat supplied to the region to be heated during formation of the third weld portion is smaller than an amount of heat supplied to the region to be heated during formation of the first weld portion.

2. The method of manufacturing the joined body according to claim 1,
wherein the control for reducing the amounts of heat is carried out such that an amount of heat supplied to the region to be heated during formation of the second weld portion is smaller than the amount of heat supplied to the region to be heated during the formation of the first weld portion and is larger than the amount of heat supplied to the region to be heated during the formation of the third weld portion.

3. The method of manufacturing the joined body according to claim 2,
wherein the control for reducing the amounts of heat is carried out such that the amount of heat supplied to the region to be heated during the formation of the first weld portion, the amount of heat supplied to the region to be heated during the formation of the second weld portion, and the amount of heat supplied to the region to be heated during the formation of the third weld portion are gradually reduced in a stepwise manner or in a continuous manner.

4. The method of manufacturing the joined body according to claim 1,
wherein the control for reducing the amounts of heat is control for reducing an output of a source for the heating.

5. The method of manufacturing the joined body according to claim 1,
wherein the control for reducing the amounts of heat is control for increasing a welding speed.

6. The method of manufacturing the joined body according to claim 1,
wherein the first weld portion, the second weld portion, and the third weld portion include portions extending parallel to each other where the third weld portion is formed between the first weld portion and the second weld portion.

7. The method of manufacturing the joined body according to claim 2,
wherein the control for reducing the amounts of heat is control for reducing an output of a source for the heating.

8. The method of manufacturing the joined body according to claim 2,
wherein the control for reducing the amounts of heat is control for increasing a welding speed.

9. The method of manufacturing the joined body according to claim 2,
wherein the first weld portion, the second weld portion, and the third weld portion include portions extending parallel to each other where the third weld portion is formed between the first weld portion and the second weld portion.

10. The method of manufacturing the joined body according to claim 3,
wherein the control for reducing the amounts of heat is control for reducing an output of a source for the heating.

11. The method of manufacturing the joined body according to claim 3,
wherein the control for reducing the amounts of heat is control for increasing a welding speed.

12. The method of manufacturing the joined body according to claim 3,
wherein the first weld portion, the second weld portion, and the third weld portion include portions extending parallel to each other where the third weld portion is formed between the first weld portion and the second weld portion.
